(19) United States
(12) Patent Application Publication
(10) Pub. No.: US 2020/0346057 A1
(43) Pub. Date: Nov. 5, 2020

(54) Fire Protection Robot for Controlling Fire Fighting Devices, Corresponding Fire Protection System and Method for Its Operation

(71) Applicant: Minimax Viking Research & Development GmbH, Bad Oldesloe (DE)

(72) Inventors: Thorsten WESTPHAL, Bad Oldesloe (DE); Marika AF ENEJEHLM, Bad Oldesloe (DE); Joachim BÖKE, Bad Oldesloe (DE)

(21) Appl. No.: 16/852,866

(22) Filed: Apr. 20, 2020

(30) Foreign Application Priority Data
Apr. 24, 2019 (EP) 19170746.2

(51) Int. Cl. A62C 27/00; A62C 3/02

(52) U.S. Cl. CPC A62C 27/00; A62C 3/0242; A62C 3/0271

(57) ABSTRACT

The invention relates to a fire-protection robot with a control unit which is configured to move the fire-protection robot along a specified navigation path, and to detect a fire-sensor unit which is configured to detect one or a plurality of fire characteristics along the specified navigation path. The fire-protection robot further comprises a communication unit which is configured to transmit an activation signal to at least one fire-fighting device in response to the detection of one or a plurality of fire characteristics, a fire-protection system comprising at least one fire-protection robot and at least one fire-fighting device as well as a corresponding method.

### PRIORITY CLAIM AND INCORPORATION BY REFERENCE

This application claims priority to European Patent Application No. 19170746.2 filed Apr. 24, 2019, the contents of which application is incorporated herein by reference in its entirety.

### TECHNICAL FIELD

The present invention relates to a fire-protection robot, a fire-protection system comprising such a fire-protection robot and a method for operating the fire-protection system.

### BACKGROUND AND SUMMARY OF THE INVENTION

In particular, the invention relates to a fire-protection robot, which can be used for (preventive) fire protection within fire-protection areas, the monitoring of which by means of a fire detector connected to a central device is not possible. Such fire-protection areas are, in particular, outdoor areas, such as industrial factory sites or extensive agricultural and/or forestry sites for example, where a relatively large area must be monitored in relatively short time intervals.

One problem with such fire-protection areas is that outdoor areas make the use of common fire detectors expensive, if not impossible. On the one hand, these fire detectors can only be mounted with a great deal of effort to cover the entire fire-protection area. On the other hand, environmental influences, such as wind, fog, rain, and the like mean that fixed fire sensors, such as those found in fire detectors, can only capture fire characteristics in a very unreliable manner. This is particularly the case because these fixed fire sensors have a limited opening angle and thus a limited detection range. This can lead to “blind spots” for the fire sensors and/or to a fire event already having to be at a very advanced state in order to be detected (e.g. via the smoke development).

Another problem is also that, within these fire-protection areas, there can often be objects with a high fire risk, such as wood, paper, chemical substances, or the like. In particular, these objects can be highly flammable and/or easily combustible so that a fire event can spread at high speed. This spread can be further enhanced by environmental influences, such as strong winds or high temperatures. Since, in such cases, even a small fire event can quickly develop into a wide spread of fire, a rapid response in the event of a fire event is urgently required in such fire-protection areas.

In accordance with the prior art, fire-protection robots equipped with a camera are therefore used to monitor such fire-protection areas. For this purpose, the fire-protection robots are moved, by remote control or automatically for example, across the fire-protection area and capture images of the fire-protection area. These images are then transmitted to a display unit at regular intervals or in real time. The users, for example, corresponding fire protection personnel who have also taken over the remote control of the fire-protection robots can view the transmitted images on the display unit and thus identify fire events. If a fire event is identified, the user can then initiate appropriate fire-protection actions.

A fire-protection action is to be understood as any action that can be used for (preventive) fire protection. For example, the user can trigger an alarm in order to warn and/or evacuate persons within the fire-protection area if necessary. In addition or as an alternative, the user can also initiate fire-fighting measures, such as calling the fire brigade or initiating a extinguishing action by means of fire-fighting devices located at the site for example, such as extinguishing turbines and/or extinguishing monitors.

A disadvantage of the prior art is to see that it requires a plurality of user actions, meaning that it comprises many steps that depend on the user's or users' action. The fact that the user first has to process the information and then make a corresponding decision regarding the fire-protection action or fire protection measures to be initiated, the procedure in accordance with prior art is inherently error-prone and lengthy.

Against this background, it is an object of the invention to provide a device, a system, and a corresponding method which allow a safe and more efficient monitoring of and/or fire-fighting in fire-protection areas of the above mentioned type to be carried out. In particular, it is an object of the invention to reduce the time until the initiation of the fire-protection action compared to prior art.

This task is achieved according to the invention by means of a fire-protection robot of the above mentioned type, which is characterized by a control unit, which is configured to move the fire-protection robot along a specified navigation path, a fire-sensor unit, which is configured to detect at least one fire characteristic along the specified navigation path, and a communication unit which is configured to transmit an activation signal to at least one fire-fighting device in response to the detection of at least one fire characteristic.

Here, a fire-protection robot is an unmanned vehicle that can be used for the purpose of (preventive) fire protection, in particular in fire-protection areas that comprise large outdoor areas. In some embodiments, the fire-protection robot can be configured for this purpose in particular as a fire-protection drone, which can move within the fire-protection area and thus test the fire-protection area for possible fire events.

For this purpose, the fire-protection robot has at least one control unit, which moves the fire-protection robot along a predefined navigation path. In particular, this navigation path can be structured in a grid-like manner. The navigation path is preferably chosen in such a way that it completely covers the fire-protection area to be monitored by the fire-protection robot. The fire-protection area to be monitored by the fire-protection robot can be the entire fire-protection area if only a single fire-protection robot is used. If a plurality of fire-protection robots are used, the fire-protection area to be monitored by a respective fire-protection robot can also only comprise a part of the entire fire-protection area, wherein the totality of all fire-protection areas to be monitored by the respective fire-protection robots forms the entire fire-protection area. This ensures that the fire-protection robot(s) can detect fire characteristics within the entire fire-protection area.

The movement of the fire-protection robot along the navigation path by means of the control unit is preferably automatic and autonomous. This means that the control unit is configured to move the fire-protection robot along the navigation path without manual control. To do this, the control unit must be able to determine the navigation path predetermined for the fire-protection robot. In some embodiments, the predetermined navigation path along the fire-protection area can be read out from a memory that is communicatively paired with the control unit. In addition or as an alternative, the control unit can also be configured to receive an instruction signal, for example, from a central device or directly from a user, and to extract the navigation path from this instruction signal by means of signal processing.

In some embodiments, the fire-protection robot can also be furthermore configured to detect obstacles along its navigation path. In this case, moving by means of the control unit can also comprise adjusting the navigation path to bypass the obstacle. On the one hand, the adjustment can be done in such a way that an alternative, predefined navigation path is read out from the memory. The fire-protection robot is then moved along the alternative, predefined path until either a new obstacle is determined—in this case, the navigation path is adjusted again, for example, according to the previously selected navigation path or another alternative navigation path—or until the movement of the fire-protection robot along the navigation path is stopped. In some embodiments, the adjustment of the navigation path can also be implemented in such a way that the fire-protection robot automatically calculates an alternative navigation path around the obstacle and then continues to move along the previously specified navigation path until either another obstacle is detected—in this case, the navigation path is adjusted again—or the movement along the navigation path is stopped.

In some embodiments, manual control can be provided in addition to automatic control by the control unit. Preferably, this manual control must be actively activated by a user. Even more preferably, enabling manual control entails entering a security code. This prevents untrained or unauthorized users from taking control of the fire-protection robot.

The fire-protection robot also comprises a fire-sensor unit, which is configured to detect at least one fire characteristic along the specified navigation path. By a fire-sensor unit, in particular, an arrangement can be understood that comprises one or a plurality of sensors for the detection of one or more fire characteristics, such as for example temperature, temperature gradient, smoke aerosols, electromagnetic radiation, fire gases, and the like.

The fire-sensor unit is preferably configured in such a way that it continuously detects the at least one fire characteristic value during the movement of the fire-protection robot along the specified navigation path in order to identify a possible fire event. In addition or as an alternative, the at least one fire characteristic can also be detected at specified intervals and/or in response to a user input.

In order to be able to react immediately in the event of a detection of at least one fire characteristic, the fire-protection robot further comprises a communication unit. The communication unit is configured to be in communicative signal connection with the other components of the fire-protection system, and in particular with at least one fire-fighting device. Here, the communication between the communication unit of the fire-protection robot and the fire-fighting device can take place directly or via a central device.

The fire-fighting device can be, in particular, an extinguishing turbine or an extinguishing monitor for outputting an extinguishing fluid. Extinguishing turbines of this type are known, for example, from WO 2015/198163. These are usually stationary devices that are used for outputting an extinguishing fluid onto a target site of a fire event, wherein the devices have a certain range.

The fire-fighting device can be permanently installed in one location or can be mobile. A corresponding system usually comprises a plurality of fire-protection robots and a plurality of (mobile and/or permanently installed) fire-fighting devices. The fire-fighting devices preferably comprise at least one extinguishing-fluid supply and at least one extinguishing-fluid outlet, wherein the at least one extinguishing-fluid supply and the at least one extinguishing-fluid outlet are fluidically connected. In some embodiments, the extinguishing-fluid supply can comprise, in particular, an extinguishing-fluid supply, for example, in the form of a fluid tank. This embodiment is advantageous in the case of mobile fire-fighting devices, as mobility can also be ensured at long distances since no extinguishing fluid line with a limited length, such as a hose or the like, is required to supply the fire-fighting device from a permanently installed extinguishing-fluid supply. In addition or as an alternative, the extinguishing-fluid supply can also be implemented as an extinguishing fluid line, which connects the fire-fighting device with an extinguishing-fluid supply network. This embodiment is advantageous in the case of permanently installed fire-fighting devices. Supplying from the extinguishing-fluid-supply network can ensure that larger amounts of extinguishing fluid can be provided than, for example, is the case with mobile tanks.

Here, the communication unit is specifically configured to generate a corresponding activation signal and transmit this activation signal to the at least one fire-fighting device upon detecting at least one fire characteristic, which indicates the presence or possibility of a fire. In response to this activation signal, the fire-fighting device is then activated. An activation of the fire-fighting device preferably comprises an alignment of the fire-fighting device in such a way that the extinguishing-fluid outlet of the fire-fighting device can output the extinguishing fluid in the direction of the fire event. In addition or as an alternative, an activation of the fire-fighting device in the case of a mobile fire-fighting device can also comprise an activation of a drive unit, by means of which the fire-fighting device is moved in the direction of the position of the fire event, meaning in the direction of a target site where the fire event occurred.

Such a target site, in particular, is the place where the fire event is actually located, meaning the target to be reached by the fire-fighting device. Here, moving a mobile fire-fighting device to the target site means that the fire-fighting device is navigated from its starting position along a movement path to an extinguishing position by a certain distance from the target site. Thus, the fire-fighting device is not arranged in the center of the place fire event, but at some distance to it. This distance is selected in such a way that the functionality of the fire-fighting device is not affected by the fire event, however, the fire can be reliably extinguished. This distance can therefore particularly depend on the range of the extinguishing-fluid outlet of the fire-fighting device, on the properties (heat, spread, etc.) of the fire event, as well as on the local conditions (wind direction, weather conditions in general, etc.).

After reaching the extinguishing position at some distance away from the target site, the mobile fire-fighting device is then also aligned accordingly in order to be able to output the extinguishing fluid to the fire located at the target site.

In some embodiments, activating can particularly comprise an initiation of a fire-protection action. Such a fire-protection action can comprise, in particular, an extinguishing action to combat the fire. In addition or as an alternative, the fire-protection action carried out by the fire-fighting device can also comprise outputting an alarm or activating other fire-fighting devices.

Even if in the above embodiments the fire-protection robots are used both for the monitoring of the fire-protection area as well as for the control of the fire-fighting devices, in other embodiments, the fire-protection robot can also be used only for monitoring or only for control. In a specific embodiment, the fire-protection robots are only used to control the fire-fighting devices and the monitoring of the fire-protection area is carried out by means of appropriately stationary masts with monitoring technology. In this case, the masts are to be understood as the fire-sensor unit of the fire-protection robot. The fire-protection robot communicates with the masts and thus determines at which position along the navigation path the respective mast has detected a fire characteristic and can thus record the fire characteristics along its navigation path.

By means of a fire-protection robot of the above-mentioned type, it is therefore possible to carry out the monitoring of the fire-protection area automatically, and autonomously initiate a fire-protection action by the fire-fighting device. This reduces the number of user interactions and the time between the detection of the fire and the initiation of the fire-protection action, in particular, the extinguishing action.

In accordance with a preferred embodiment, the control unit determines the specified navigation path based on navigation data, which comprise a navigation grid with a plurality of grid coordinates, wherein the navigation grid defines a fire-protection area.

In some embodiments, the control unit is configured to determine the specified navigation path for the fire-protection robot based on navigation data. In this case, navigation data is a data set that comprises a plurality of grid coordinates. These grid coordinates form a navigation grid over the fire-protection area. In this embodiment, the navigation path is determined by means of a grid, which is placed over the entire area to be monitored. This ensures that each position within the grid used can be assigned to a position within the fire-protection area.

By breaking down the fire-protection area into a corresponding grid, it is possible to achieve a precise determination of the positions within the fire-protection area, even if the fire-protection area is very large and/or is enlarged over time.

In accordance with another preferred embodiment, the control unit is configured to adjust the specified navigation path in response to capturing at least one fire characteristic.

In some embodiments, the fire-protection robot is configured to deviate from its predetermined navigation path if the fire-sensor unit detects a fire characteristic at a certain position and this fire characteristic indicates a fire event.

Instead of moving the fire-protection robot away from the position of the (potential) fire event in such a case, as specified by the navigation path, the control unit can react to the detection of at least one fire characteristic with a stop of the fire-protection robot and a lingering at the position where the at least one fire characteristic has been detected. The control unit can also be configured to arrange the fire protection device to detect other fire characteristics by means of the fire-sensor unit in the immediate vicinity around the position at which the fire characteristic was detected in order to obtain more precise information about the fire event. In addition or as an alternative, the control unit can cause the fire-protection robot to take pictures of the position at which the fire characteristic was detected and/or its immediate vicinity—and thus the (potential) fire event—if the fire-protection robot has a camera. In addition or as an alternative, in response to an identification of an actual fire event, the control unit can also cause the fire-protection robot to carry out a first-extinguishing attack, provided that the fire-protection robot comprises a fire-fighting unit.

The fire-protection robot can furthermore be configured to determine the target site of the (potential) fire event in response to the determination of the fire characteristic and, on the basis of the target site, to determine a safety position to which the fire-protection robot can navigate. The safety position is understood, in particular, as a position at which the fire-protection robot is located outside the danger zone of the fire event but can continue to detect fire characteristics at the target site and/or perform an initial extinguishing action. In some embodiments, in addition or as an alternative, the safety position can correspond to a position of the fire-protection robot at which it is ensured that the fire-protection robot is not arranged in an outlet area of the extinguishing-fluid outlet of a fire-fighting device. This ensures, on the one hand, that the fire-protection robot is not damaged or even destroyed by the penetrating extinguishing fluid and, on the other hand, that the extinguishing fluid is completely output onto the fire event.

The adjustment of the navigation path is preferably linked to certain boundary conditions. In some embodiments, this means that the adjustment of the navigation path should not happen in such a way that the fire-protection robot collides with another fire-protection robot and/or a stationary and/or mobile fire-fighting device. In addition or as an alternative, the boundary conditions can also be provided in such a way that the adjustment of the navigation path is only carried out in such a way that the fire-protection robot always remains in the fire-protection area to be monitored by it. The adjustment of the navigation path should therefore only be carried out in such a way that the fire-protection robot is not led out of the predetermined fire-protection area.

In another preferred embodiment, the fire-protection robot furthermore comprises a processor unit, which is configured to determine a target site of a fire event on the basis of at least one fire characteristic and navigation data. In a modification, the communication unit is configured to transmit a target-site indication for the target site of the fire event to the fire-fighting device and/or at least another fire-protection robot.

In some embodiments, the fire-protection robot also comprises a processor unit. A processor unit can in particular comprise a microprocessor, a microcontroller or another (digital) computing unit, which can be programmed to determine a target site on the basis of the fire characteristic as well as the grid coordinates. Here, a target site is the position within the fire-protection area where the (potential) fire event occurred. This target site can also be specified within the grid, which is stretched over the fire-protection area, by corresponding grid coordinates.

The fire-protection robot can then use this determination of the target site to carry out a further analysis of the fire event on and in the immediate vicinity around the target site. For example, the fire-sensor unit of the fire-protection robot can be used to re-collect fire characteristics at and in the immediate vicinity around the target site.

In some embodiments, the fire-protection robot can further generate a target-site indication of the determined target site and transmit this target-site indication to the fire-fighting device and/or another fire-protection robot. For this purpose, the computing unit of the fire-protection robot is preferably configured to generate the target-site indication and the communication unit of the fire-protection robot is further configured to transmit the target-site indication to at least one fire-fighting device and/or to at least one other fire-protection robot.

Here, the communication unit can be configured to transmit the target-site indication directly to the fire-fighting device. In order to ensure an efficient operation of the system in this case, it is preferred that the fire-protection robot is aware of information about the locations of the individual fire-fighting devices located within the fire-protection area to be monitored by the fire-protection robot. For this purpose, the fire-protection robot can preferably comprise a memory unit, in which corresponding site indications about the locations of the stationary fire-fighting devices are stored. In addition or as an alternative, the communication unit can be configured to receive location indication signals from the stationary and/or mobile fire-fighting devices and to extract from these location indication signals the individual location indications of the respective fire-fighting devices.

Furthermore, it is preferred that the fire-protection robot knows the fire-protection robot locations of the other fire-protection robots within the fire-protection area. In order to determine the fire-protection robot locations, the communication device of the fire-protection robot is specifically configured to receive corresponding indication signals from the individual fire-protection robots and to extract a corresponding indication about the fire-protection robot location of the respective fire-protection robot from these signals. In this way, the fire-protection robot can determine which other fire-protection robots and/or fire-fighting devices are located near the target site and thus can either quickly reach the target site—or the corresponding safety and/or extinguishing position—or, in the event that they are already near the target site, immediately initiate a fire-protection action. This allows a quick and efficient initiation of the fire-protection action.

The communication unit is configured to transmit the target-site indication to at least one stationary and/or mobile fire-fighting device. A stationary fire-fighting device can preferably use the target-site indication to align itself in the direction of the fire event and to carry out the fire-protection action at the target site. In a specific embodiment in which the fire-protection action comprises an extinguishing action, the fire-fighting device is configured, in particular, to use the target-site indication to align its extinguishing-fluid outlet in the direction of the target site.

In the case of a mobile fire-fighting device, the fire-fighting device can use the target-site indication to automatically navigate along the movement path to the corresponding target site. For this purpose, the mobile fire-fighting device preferably comprises navigation information about the fire-protection area. In some embodiments, this navigation information can also comprise corresponding grid coordinates. In some embodiments, the navigation information also comprises map data, which comprise information about the terrain to be driven on. When the mobile fire-fighting device arrives at its target site, it can use the target-site indication to align itself in a suitable position in relation to the target site. In the specific embodiment in which the fire-protection action comprises an extinguishing action, this can comprise, in particular, a positioning in the extinguishing position distanced away from the target site and an alignment of the extinguishing-fluid outlet in the direction of the target site.

In addition or as an alternative, the fire-protection robot can also transmit the target-site indication to at least one other fire-protection robot. The at least one other fire-protection robot can then use the target-site indication in order to move, preferably automatically, to the target site and, for its part, carry out a fire-protection action there. In some embodiments, the fire-protection action can comprise a review of the measurement by the first fire-protection robot. In some embodiments, the at least one other fire-protection robot—in contrast to the fire-protection robot located at the target site—can be equipped with a fire-fighting unit and initiate an initial extinguishing action as a fire-protection action. Other types of fire-protection actions are conceivable.

In some embodiments, the fire-protection robot can be configured to communicate via a direct signal connection with the at least one fire-fighting device and/or the at least one other fire-protection robot. In addition or as an alternative, the fire-protection robot can be configured to establish a communication connection with a central device and communicate via the central device with the at least one fire-fighting device and/or the at least one other fire-protection robot. The advantage of an embodiment in which the fire-protection robot communicates via the central device is that the fire-protection robot must have less information about the other fire-protection robots and/or the fire-fighting devices available. Thus, in such a case, for example, the fire-protection robot does not first have to determine the locations of the at least one fire-fighting device and/or the other fire-protection robots, since the determination of which fire-fighting devices must be activated and/or fire-protection robots must be addressed can be made by the central device. This reduces the computing and storage costs of the fire-protection robot.

Another advantage can be seen in the fact that communication via the central device facilitates updating the fire-protection system. For example, additional fire-protection robots and/or mobile and/or fixed fire-fighting devices can be added with less communication effort, since this information is centrally stored in the central device and also only needs to be updated there.

In some embodiments, the fire-protection robot furthermore comprises an environmental sensor unit, which is configured to determine at least one ambient parameter along the navigation path, wherein the control unit is configured to adjust the navigation path in response to the detection of at least one fire characteristic based on the at least one ambient parameter.

In some embodiments, the fire-protection robot comprises an environmental sensor unit in addition to the fire-sensor unit. The environmental sensor unit preferably comprises one or a plurality of sensors, which are used to detect ambient parameters.

An ambient parameter within the meaning of the invention can comprise, in particular, a parameter or be a parameter that transmits additional information about the local conditions within the fire-protection area. This additional information can hereby comprise wind strength, wind speed, wind direction, temperature, humidity, or the like for example. In addition or as an alternative, this additional information can also indicate the presence of obstacles along the navigation path of the fire-protection robot and/or along the movement path of the at least one mobile fire-fighting device. In the case where the environmental sensor unit is used to identify obstacles along the navigation path of the fire-protection robot, the fire-protection robot can then bypass these obstacles as described above by adjusting the navigation path. In the case in which the environmental sensor unit is used to identify obstacles along the movement path of the at least one mobile fire-fighting device, the fire-protection robot can, in particular, add an obstacle indication into the activation signal transmitted to the mobile fire-fighting device, wherein the movement path of the mobile fire-fighting device is adjusted accordingly. Alternatively, the obstacle indication can also be transmitted to the mobile fire-fighting device in a dedicated obstacle signal, which differs from the activation signal.

In addition or as an alternative, the mobile fire-fighting device itself can comprise an anti-collision sensor, which is configured to identify obstacles along the movement path. This results in a higher safety against collisions, as it is always possible that the fire-protection robot located away from the fire-fighting device does not detect an obstacle along the movement path of the fire-fighting device.

By detecting one or a plurality of ambient parameters along the navigation path, the fire-protection robot is preferably able to predict the direction and speed of the spread of a fire event. This allows the fire-protection robot to adjust its navigation path accordingly in order to be able to track the fire event and, in particular, in the case of obstacles, to determine the navigation path of the fire-protection robot and/or the movement path of the mobile fire-fighting device, which moves the fire-protection robot and/or the mobile fire-fighting device into the safety or extinguishing position the fastest.

For the adjustment, the fire-protection robot can in particular use the navigation data that were previously transmitted to it and adjust the grid points in it accordingly. This enables the fire-protection robot to precisely and reliably identify additional information about a possible fire event.

In some embodiments, the communication unit is configured to transmit the at least one fire characteristic and/or the at least one ambient parameter to the fire-fighting device.

The communication unit of the fire-protection robot can also be configured to transmit the recorded fire characteristics and/or the recorded ambient parameters and/or the prediction of the direction of propagation and/or propagation speed of the fire event based thereon to the fire-fighting device.

In some embodiments, the communication unit is configured to insert this information into the activation signal and then transmit it as part of the activation signal. In addition or as an alternative, a separate information transmission signal can also be transmitted to at least one fire-fighting device for this information. In some embodiments, the activation signal and/or the information transmission signal modified in this way can furthermore receive a fire-event-specific indication on which steps are to be initiated by the fire-fighting device. This allows for improved automated planning and/or implementation of the fire-protection action to be achieved.

In a preferred embodiment, the fire-protection robot comprises at least one camera, which is configured to generate at least one image of the location of the fire protection event in response to the detection of at least one fire characteristic.

In some embodiments, the fire-protection robot can additionally comprise at least one camera. This camera can be used to capture images of the (potential) fire events. For this purpose, the camera can be an ordinary digital camera that can take visual images of the fire event. In a specific embodiment, the camera can also be a thermal camera. The advantage of a thermal camera is that the thermal camera allows the necessary additional information to be determined, such as temperature and the internal structure of the fire. This allows for as much information as possible to be collected about the fire.

In these embodiments, the camera can preferably be configured to be aligned on the basis of the target-site indication. This means that the camera is configured to align in the direction in which fire characteristics were detected. This allows for the position at which possible fire characteristics are detected to always be recorded in an image.

In some embodiments, the camera is preferably activated in response to the detection of at least one fire characteristic. This means that if at least one fire characteristic is detected by means of the fire-sensor unit, this causes a camera activation signal, which causes the camera to take pictures of the identified target site and, if necessary, its surroundings. This has the advantage that images are only collected and saved if there is a need for them. This allows the memory of the camera and/or the communication effort between the camera and a central device for transmitting the images to be kept at a low level.

Alternatively, the camera can also be configured to generate images continuously, meaning regularly at specified time intervals. A permanent activation of the camera has the advantage that images of all parts of the fire-protection area are available. This allows, for example, an early detection of failures and/or malfunctions of the fire-sensor unit.

In some embodiments, the camera can also be activated manually. In these cases, the user can activate and/or align the camera using an appropriate user interface and decide for himself when to record shots from the camera. In some embodiments, the camera can also be configured semi-automatically. In particular, the activation and alignment of the camera can be done manually, while the image can be taken automatically, for example at certain predefined intervals. In some embodiments, the control unit is configured to receive an external navigation signal and adjust the navigation path based on the external navigation signal.

In some embodiments, the control unit can additionally be configured to control the fire-protection robot in response to an external navigation signal and thus adjust the automatically determined navigation path. Here, the external navigation signal can be a signal which is provided by a remote control of a user which thus represents a user input. In some embodiments, the remote control of the user is connected to a central device. In this case, the remote control communicates with the fire-protection robot via the central device. In this case, the control unit can be configured to receive the external navigation signal directly or via the communication unit. In some embodiments, the remote control of the user can also be an independent device that communicates directly with at least one fire-protection robot.

Here, the control by a user can preferably be carried out camera-guided if the fire-protection robot comprises a camera. For this purpose, the camera can be activated by the user in particular or can already be active. In addition or as an alternative, the control can also be done on the basis of the navigation grid, which is displayed to the user. In this embodiment, the position of the fire-protection robot is displayed on a grid on a user interface. The user can then navigate the fire-protection robot based on this display. In addition or as an alternative, the control can also be semi-automatic, for example, by the user specifying a target site for the fire-protection robot and then the fire-protection robot automatically determines a navigation path based on the target site. This determination can be determined in particular on the basis of ambient parameters available to the fire-protection robot, such as wind direction, wind strength, possible obstacles, etc.

In some embodiments, the user can also manually control the stationary and/or mobile fire-fighting devices. In this context, manual control may particularly be understood as referring to the manual alignment of the extinguishing-fluid outlet in the direction of the fire event. Preferably, the user can manually align both the extinguishing-fluid outlet of a stationary as well as a mobile fire-fighting device. In the case of a mobile fire-fighting device, manual control can furthermore comprise navigating along the movement path from a location towards the target site, in particular to the extinguishing position. In some embodiments, both manual alignment as well as manual navigation by the user can be carried out on the basis of camera shots by a camera of the fire-protection robot.

In some embodiments, the communication unit is configured to transmit an alarm signal to a receiver unit of an external fire protection station in response to the detection of at least one fire characteristic. In some embodiments, the alarm signal comprises the target-site indication.

An external fire protection point means terminal devices at external providers of (preventive) fire protection. For example, the communication unit can be configured to transmit an alarm signal to a receiver at a fire brigade to inform the fire brigade of the fire event. The fire brigade can then take appropriate fire-fighting measures.

In some embodiments, the fire-fighting measures comprise, in particular, a deployment of the fire brigade to combat the fire event. In some embodiments, the fire-protection robots are specifically configured to navigate the fire-fighting vehicles being deployed for this purpose. This preferably occurs by transmitting the target-site indication. This target-site indication can be transmitted as part of the alarm signal. Alternatively, the target-site indication can also be transmitted in a separate signal.

Based on the target-site indication, the fire brigade can then determine the target site of the fire event and a corresponding path to the target site.

Although, in the above embodiments, the fire-protection robots are configured to control the fire-fighting devices and to navigate the fire-fighting vehicles, the fire-protection robots can also be configured to control only the fire-fighting devices or to navigate only the fire-fighting vehicles. In some embodiments, a plurality of fire-protection robots can also be used, some of which is used to control the fire-fighting devices and part of the navigation of the fire-fighting vehicles. The target-site indication can be the same for both fire-protection robots.

In some preferred embodiments, the fire-protection robot comprises a fire-fighting unit.

In some embodiments, the fire-protection robot further comprises a fire-fighting unit, which can be used for the initial fight of the fire. Preferably, the fire-fighting unit is an extinguishing unit, which comprises an extinguishing-fluid supply or is connected to one, as well as an extinguishing-fluid outlet for emitting the extinguishing fluid onto the fire. In this case, the fire-protection robot can preferably use the target-site indication internally to align the extinguishing-fluid outlet of its extinguishing unit in the direction of the target site, thus outputting the extinguishing fluid onto the target site.

By means of such a fire-fighting unit, the fire-protection robot can perform an initial extinguishing in order to contain or control the fire until the fire-fighting devices are activated. This constellation is particularly advantageous if the fire-fighting devices are mobile and may require a certain amount of time to reach the target site.

In some embodiments, the fire-protection robot is implemented as a fire-protection drone. The fire-protection robot according to the invention can be implemented as an unmanned land vehicle or aircraft. An embodiment designed as an aircraft is particularly preferred, in particular, designed as a drone. The advantage of an embodiment as a fire-protection drone is that a drone is also easy to navigate across uneven terrain and also allows a good overview of the fire-protection area in case of obstacles or the like. Particularly preferable, the drone is designed as a fire-fighting drone, which comprises an extinguishing unit for carrying out an initial extinguishing action.

In another aspect, the invention further relates to a fire-protection system comprising at least one fire-protection robot as described above and at least one fire-fighting device comprising a receiver unit for receiving the activation signal from the fire-protection robot, wherein the fire-fighting device is configured to initiate a fire-protection action in response to the activation signal.

The invention furthermore relates to a fire-protection system, comprising a fire-protection robot of the above type and at least one fire-fighting device. Preferably, the fire-protection system comprises a plurality of fire-protection robots and a plurality of fire-fighting devices in particular.

The fire-protection robots are configured in such a way that, if they are not active, they remain in a parking position. This parking position preferably comprises a position in which the fire-protection robots are connected to appropriate charging stations in order to be charged. In addition or as an alternative, the fire-protection robots can be serviced in the parking position. In the case of an existing fire-fighting unit, it can also be made ready for operation in the parking position.

The plurality of fire-protection robots are preferably configured to alternately monitor the fire-protection area. For this purpose, the fire-protection robots are configured to move out of the parking position at regular intervals and navigate along a specified navigation path through the fire-protection area. The intervals at which the fire-protection robots leave the parking position and return to it have been preferably pre-programmed and/or determined by a user. Here, the length of the intervals can depend in particular on the number and battery power of the fire-protection robots and the size of the fire-protection area.

It is particularly preferred that the navigation paths for a plurality of fire-protection robots used simultaneously are determined in such a way that they have the fewest overlaps as possible. On the one hand, this can prevent collisions, and, on the other hand, more efficient monitoring can be carried out.

It is further preferred that the plurality of fire-protection robots is configured to communicate with each other. This can be used, for example, to ensure that in the event of a defect of a fire-protection robot, it communicates with another fire-protection robot so that the other fire-protection robot is activated for monitoring instead of the defective fire-protection robot. This ensures that a sufficient number of fire-protection robots always monitor the fire-protection area.

The fire-fighting devices within the fire-protection system can be stationary. In this case, the fire-fighting devices thus are permanently installed at a location within the fire-protection area. In addition or as an alternative, the fire-protection system can also comprise one or a plurality of mobile fire-fighting devices. In any case, the fire-fighting devices do not have a permanently defined location. However, the fire-protection system is preferably configured to determine the location of the mobile fire-fighting devices at any time.

The mobile fire-fighting devices are preferably configured to assume an inactive position in the inactivity state, in which the fire-fighting devices are parked at one location. Preferably, the fire-fighting devices are configured to be charged in the inactivity position by a charging station. In addition or as an alternative, the fire-fighting devices in the inactivity position can also be serviced and/or made ready for fire-fighting again.

The fire-fighting devices move out of this inactivity position as soon as they receive the activation signal. Preferably, after their activation, the fire-fighting devices follow corresponding navigation paths, which are preferably determined in such a way that the individual fire-fighting devices do not collide with each other or with stationary fire-fighting devices.

In accordance with a preferred embodiment, the fire-protection system further comprises a central device comprising a central communication unit, which is configured to receive the activation signal from the at least one fire-protection robot and, in response to receiving, to transmit it to at least one fire-fighting device.

In some embodiments, the fire-protection system further comprises a central device. The central device can be configured in particular to serve as a central processing point of all information collected and exchanged within the system. Furthermore, the central device can be configured as a communication interface between the at least one fire-protection robot and the at least one fire-fighting device. In addition or as an alternative, the central device can also serve as a communication interface for the user.

In some embodiments, the central device can particularly comprise a fire alarm center, extinguishing control center, or the like or be configured as part of a fire alarm center, extinguishing control center or the like. In some embodiments, the central device can also be an independent control panel, which does not fulfil functionalities of the fire alarm control center, the fire control center or the like, but serves only the centralization of the information of the fire-protection robots and the fire-fighting devices. The central device can therefore be configured in such a way that the information of the fire-protection robots converges in it in order to be transmitted to the individual fire-fighting devices.

In some embodiments, the central device is to be configured, upon receiving an activation signal from a fire-protection robot, to forward this activation signal to the fire-fighting devices within the system. In one embodiment, the central device also receives a target-site indication indicating the target site of the fire event. The target-site indication is preferably specifying a grid position within the navigation grid.

The central device is preferably configured to use this target-site indication to identify those stationary fire-fighting devices whose location is located near the target site. The central device is further configured to transmit the activation signal to the fire-fighting devices identified in this manner. Furthermore, the central device is preferably configured to transmit the target-site indication to the mobile fire-fighting devices in order to enable them to navigate to the target site of the fire event. In addition or as an alternative, the central device can be configured to transmit to the mobile fire-fighting devices also a corresponding navigation path, determined on the basis of the target-site indication.

In accordance with a modification, the central device comprises a display unit and a user interface, wherein the display unit is configured on the basis of navigation data, which comprise a navigation grid with a plurality of grid coordinates, to generate a first graphical representation of the navigation grid, wherein the navigation grid defines the fire-protection area, and furthermore, a second graphical representation of a location of the at least one fire-protection robot and/or a location of the at least one fire-fighting device, and to display the first and second graphical representation to a user, and wherein the user interface is configured to receive input from the user and generate user control signal based on the input. In another preferred embodiment, the user control signal comprises an external navigation signal for at least one fire-protection robot and the central communication unit is configured to transmit the external navigation signal to the at least one fire-protection robot.

In some embodiments, the central device comprises a display unit and a user interface. The display unit can be configured in particular as a screen in the central device. Here, the display unit can also be configured as a touchscreen and can thus simultaneously serve as a user interface for receiving user input. In addition or as an alternative, the user interface can also be configured as a keyboard, mouse, or the like.

The display unit is preferably configured to provide a graphical representation of the fire-protection area. For this purpose, the display unit can generate a first graphical representation of a navigation grid, which is placed over the fire-protection area, and a second graphical representation, which indicates the location of the at least one fire-protection robot. In some embodiments, the second graphical representation particularly comprises a plurality of fire-protection-robot locations. In this case, the user can select a fire-protection robot by means of the user interface and activate it manually via a corresponding user control signal and/or view and/or adjust its operating parameters and/or settings.

In some embodiments, the second graphical representation furthermore comprises the at least one fire-fighting device. This is preferably shown in such a way that it can be distinguished by at least one fire-protection robot. If the second graphical representation also comprises the fire-fighting devices, these can be activated analogously to the fire-protection robot by means of the user interface and/or their operating parameters can be adjusted.

In some embodiments, the user control signal can also comprise an external navigation signal, which allows the user to control the fire-protection robots and/or the fire-fighting devices via the central device. For this purpose, the second graphical representation can be displayed on the display unit superimposed over the first graphical representation. This allows the user to identify the location of the fire-protection robots and/or fire-fighting devices within the fire-protection area and to navigate the fire-protection robots and/or the (mobile) fire-fighting devices on the basis of this identification. For this purpose, the user can manually select the fire-protection robots and/or fire-fighting device to be navigated beforehand.

In accordance with another embodiment, the fire-protection system furthermore comprises at least one fire-fighting device, which is configured as a stationary fire-fighting device. In some modifications, the receiver device is further configured to receive a target-site indication for the target site of the fire event, wherein the fire-fighting device comprises at least one alignment unit, which is configured to align an extinguishing-fluid outlet of the fire-fighting device based on the target-site indication in the direction of the target site.

In some embodiments, the fire-protection system preferably comprises a plurality of fire-fighting devices, wherein at least one of them is stationary. In the case of the at least one stationary fire-fighting device, the activation signal is transmitted only to those stationary fire-fighting devices located so close to the target site of the fire event that they can effectively combat the fire event. This means that the target site must be within range of the fire-fighting device. This range varies depending on how the extinguishing fluid is output. It is usually between 50 and 200 m, preferably between 70 and 100 m. In a specific embodiment, the range is 70 to 80 m for a full jet and 40 to 50 m for a spray jet.

The selection of the respective fire-fighting devices can be carried out by the fire-protection robot. In addition or as an alternative, the central device can make this selection.

In some embodiments, all stationary fire-fighting devices can also receive the activation signal. In this case, the fire-fighting devices preferably comprise each a computing unit, which is configured, preferably based on the target-site indication, to check whether the respective fire-fighting device is close enough to the target site to fight the fire. The computing unit is configured to initiate the fire-protection action, in particular, the fire-fighting action, only if the test is positive.

In addition or as an alternative, the central device and/or the at least one fire-protection robot can be configured to make a pre-selection and transmit the activation signal only to a pre-selected subset of fire-fighting devices. In this case, the fire-fighting devices also determine, preferably based on the target-site indication, whether they can fight the fire efficiently and only start with fire-fighting if the test is positive. In addition or as an alternative, the fire-fighting devices can also preventively output extinguishing fluid into the environment of the fire event, i.e. output the extinguishing fluid onto an area in which the fire has not yet spread. This can prevent the spread of the fire to this area and/or slow it down at best.

In some embodiments, the fire-protection system furthermore comprises at least one fire-fighting device, which is designed as a mobile fire-fighting device comprising at least one drive unit. In some modifications, the receiver unit is furthermore configured to receive a target-site indication for the target site of the fire event, and the at least one drive unit is configured to automatically navigate the at least one fire-fighting device to the target site of the fire event based on the target-site indication and, upon reaching the target site, align an extinguishing-fluid outlet of the fire-fighting device towards the target site of the fire event.

In some embodiments, in addition or as an alternative, the fire-protection system can also comprise one or a plurality of mobile fire-fighting devices, i.e. fire-fighting devices having a drive unit that allows them to drive from one place to another. These fire-fighting devices can be configured to evaluate the target-site indication in order to determine the target site of the fire event. Then, the fire-fighting devices can be configured to determine a movement path to the target site and to navigate to the target site. Preferably, this navigation is performed automatically in response to the activation signal. In addition or as an alternative, the fire-fighting devices can also be configured to be navigated via a remote control. In this case, it is not necessary to determine a navigation path. If such a navigation path has nevertheless been determined, it can be displayed to the user, so that the user can follow the navigation path during remote control if desired.

In another aspect, the invention relates to a method for operating a fire-protection system, comprising the steps: (a) moving at least one fire-protection robot (1) along a specified navigation path, (b) recording at least one fire characteristic along the specified navigation path, and (c) transmitting, in response to the detection of at least one fire characteristic, an activation signal to at least one fire-fighting device. In some embodiments, the method furthermore comprises the step: (d) activating, in response to the activation signal, of the at least one fire-fighting device. In some embodiments, step (c) furthermore entails transmitting a target-site indication for a target site of a fire event. The method also comprises the step (e) automatic navigation of the at least one fire-fighting device based on the target-site indication to the target site of the fire event.

The method according to the invention makes use of the advantages and preferred embodiments of the fire-protection robot according to the invention and the fire-protection system according to the invention. The preferred embodiments and further embodiments of the fire-protection robot, as well as the fire-protection system are therefore simultaneously preferred embodiments and further embodiments of the method, which is why reference is made in this regard to the above explanations.

### BRIEF DESCRIPTION OF THE DRAWINGS

The invention will be explained in further detail in the following taking the enclosed figures into account based on preferred exemplary embodiments. The figures show:

FIG. 1 a schematic representation of a fire-protection system in accordance with a first embodiment.

FIG. 2 a schematic representation of a fire-protection robot in accordance with the first embodiment.

FIG. 3 a schematic representation of a fire-protection system in accordance with a second embodiment.

FIG. 4 a schematic representation of a fire-protection system according to the invention in accordance with a third embodiment.

FIG. 5 a schematic representation of a display device comprising a graphical representation of the fire-protection area and the fire-protection robots contained therein.

### MODE(S) FOR CARRYING OUT THE INVENTION

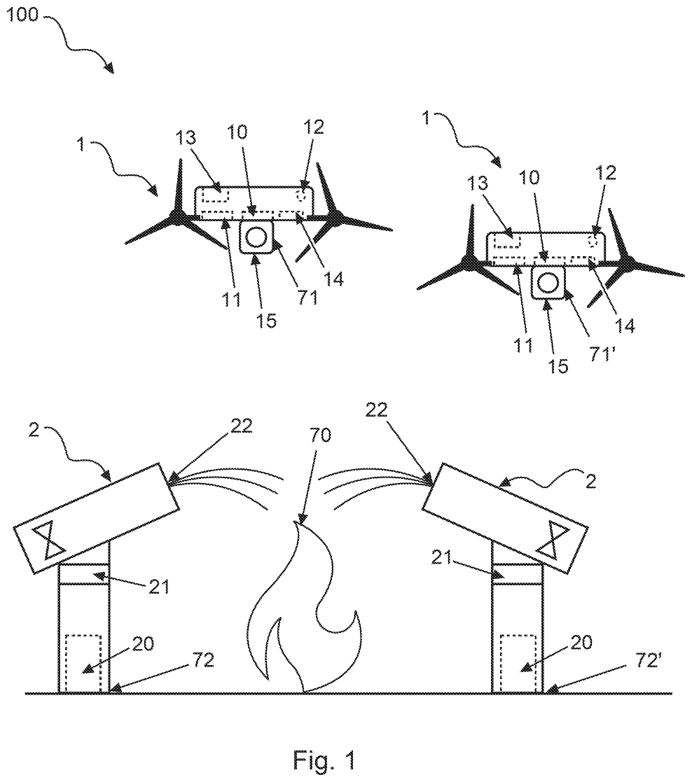

FIG. 1 schematically shows a fire-protection system 100. The fire-protection system 100 comprises the fire-protection robots 1, which are designed as fire-protection drones in the embodiment of the fire-protection system 1, and the stationary fire-fighting devices 2.

The fire-protection robots 1 each comprise a control unit 10, a fire-sensor unit 11, a communication unit 12, a processor unit 13, an environmental sensor unit 14 and a camera 15 and are located at protective positions 71 and 71′. The stationary fire-fighting devices 2 each comprise a receiver unit 20, an alignment unit 21 and an extinguishing-fluid outlet 22 and are located at the extinguishing positions 72 and 72′. Even if, for the simplification of the presentation, only two fire-protection robots 1 and two stationary fire-fighting devices 2 are shown in FIG. 1, the fire-protection system 100 comprises a plurality of fire-protection robots 1 and stationary fire-fighting devices 2.

In the specific example of FIG. 1, a fire-protection robot 1 is configured to monitor a fire-protection area assigned to it. For this purpose, the fire-protection robot 1 is navigated through the fire-protection area by means of the control unit 10 along a specified navigation path. In the specific embodiment of FIG. 1, in which the fire-protection robots 1 are designed as fire-protection drones, this means that the fire-protection robot 1 drives through the fire-protection area according to the navigation path.

In the specific embodiment of FIG. 1, the control unit 10 determines the navigation path based on navigation data that comprise a navigation grid with a plurality of grid coordinates. The navigation grid is configured to completely define the fire-protection area to be covered by the fire-protection robot 1. On the basis of the navigation data, it is possible to the control unit 10 of the fire-protection robot 1, the position, in the case of the embodiment of FIG. 1 to determine the safety position 71 of the fire-protection robot 1 along the navigation path.

While navigating along the navigation path through the fire-protection area, at least one fire characteristic is recorded by means of the fire-sensor unit 11. For this purpose, the fire-sensor unit 11 comprises one or a plurality of sensors, each of which serves to determine a specific fire characteristic.

Furthermore, while navigating, the environmental sensor unit 14 of the fire-protection robot 1 is used to determine ambient parameters of the environment of the fire-protection area along the navigation path. In the specific embodiment of FIG. 1, the environmental sensor unit 14 determines, in particular, the weather conditions within the fire-protection area, as well as possible obstacles on the navigation path. If obstacles are detected or if it is determined that a navigating should not be continued as specified due to the weather, this information of the environmental sensor unit 14 can be passed on to the control unit 10. The control unit 10 can then adjust the navigation path accordingly.

If the fire-sensor unit 11 along the navigation path detects at least one fire characteristic that is indicative of a fire event, the fire characteristic can be specified together with the navigation data to the processor unit 13. The processor unit 13 then determines, on the basis of the fire characteristics and the navigation data, the target site 70 of the fire event and thus the target site where the fire-fighting should take place. The processor unit 13 then generates a target-site indication indicating where the target site 70 is located.

In the specific embodiment of FIG. 1, the detection of at least one fire characteristic furthermore causes an activation of the camera 15 of the fire-protection robot 1, which is designed as a thermal camera in the embodiment of FIG. 1. The camera 15 receives the target-site indication from the processor unit 13. In response to the target-site indication, the camera aligns its memory chip in the direction of the target site 70 and thus takes at least a thermal image of the target site 70.

The camera 15 then transmits the thermal image to the processor unit 13. The processor unit 13 evaluates the thermal image and is configured to confirm that a fire event has occurred based on the thermal image for example, as well as to determine the specifications of the fire event, such as propagation, temperature, and the like. In some embodiments, the target-site indication can also be specified more precisely on the basis of the thermal image.

In the embodiment of FIG. 1, the processor unit 13 evaluates the thermal image to determine whether a fire event actually exists. If a fire event is confirmed, the processor unit 13 transmits a corresponding indication and the target-site indication to the communication unit 12.

Thereby, the communication unit 12 is caused to transmit an activation signal comprising the target-site indication to the receiver unit 20 of at least one stationary fire-fighting device 2. In the specific embodiment of FIG. 1, the communication unit 12 is particularly configured to determine which stationary fire-fighting devices 2 are located near the target site 70 on the basis of the target-site indication and transmit the activation signal comprising the target-site indication to exactly the stationary fire-fighting devices 2 whose location is near the target site 70.

The stationary fire-fighting devices 2 receive, via the receiver unit 20, the activation signal and are configured to determine the target site 70 of the fire event based on the target-site indication. In response to the determination of the target site 70, the alignment unit 21 is caused to align the respective fire-fighting device 2 in the direction of the target site 70, thus moving into the extinguishing position 72, 72′. In the case of a fixed fire-fighting device 2, the extinguishing position 72, 72′ is therefore a position in which the fire-fighting device 2, located at a specified location, has aligned in the direction of the target site 70 of the fire event.

In the specific embodiment of FIG. 1, for this purpose, the extinguishing-fluid outlet 22 of the fire-fighting device 20 is aligned in the direction of the target site 70. Following alignment, the activation signal causes the fire-fighting device 2, to initiate a fire-protection action that is carried out in the embodiment of FIG. 1 comprising an extinguishing action, i.e. outputting extinguishing fluid onto the fire.

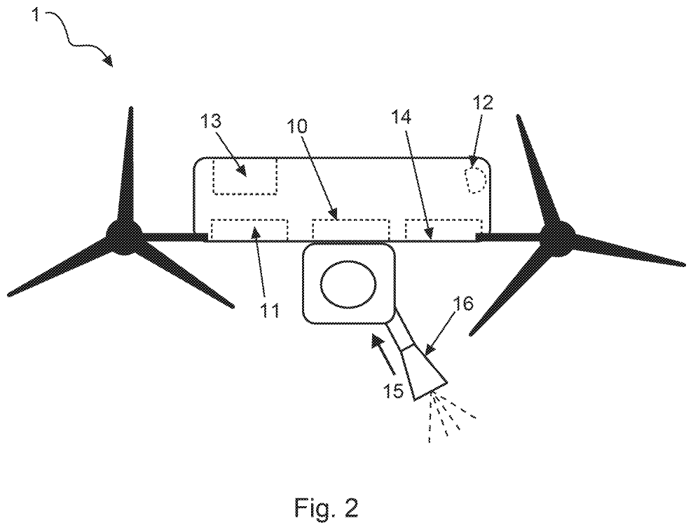

FIG. 2 shows a schematic representation of a fire-protection robot 1 according to the invention in a second embodiment. In the embodiment of FIG. 2, the fire-protection robot 1 is again designed as a fire-protection drone and comprises a control unit 10, a fire-sensor unit 11, a communication unit 12, a processor unit 13, an environmental sensor unit 14, a camera 15 and a fire-fighting unit 16.

The functionality of the fire-protection robot 1 in accordance with FIG. 2 corresponds to the functionality as is described in connection with FIG. 1. Unlike in FIG. 1 however, the fire-protection robot 1 in the embodiment of FIG. 2 also comprises the fire-fighting unit 16 for carrying out an initial action. In the embodiment of FIG. 2, the fire-fighting unit 16 is designed as a fire-fighting unit for carrying out an initial extinguishing action.

In this embodiment, the detection of the at least one fire characteristic by the fire-sensor unit 11 of the fire-protection robot 1 and the confirmation of the fire event by means of the thermal image of the camera 15 lead to an activation of the fire-fighting unit 16.

For this purpose, the control unit 10 and the fire-fighting unit 16 obtain the target-site indication from the processor unit 13. In response to the target-site indication, the control unit 10 causes the fire-protection robot 1 to position itself in the safety position 71, in which the fire-protection robot 1 is arranged so that, on the one hand, it is not damaged by the fire event, but, on the other hand, can perform an initial extinguishing action. Furthermore, the target-site indication causes the fire-fighting unit 16 of the fire-protection robot 1 to orientate itself towards the target site 70 so that the fire-fighting unit 16 can initiate the initial combat action. In the specific embodiment of FIG. 2, in which the fire-fighting unit 16 is a fire-fighting unit, the fire-fighting unit 16 thus aligns the extinguishing-fluid outlet in the direction of the target site 70 and then initiates the first extinguishing action. Preferably, the fire-protection robot 1 continues the detection of the fire characteristic by the fire-sensor unit 11 during the first extinguishing action in order to collect information about the effectiveness of the first extinguishing action.

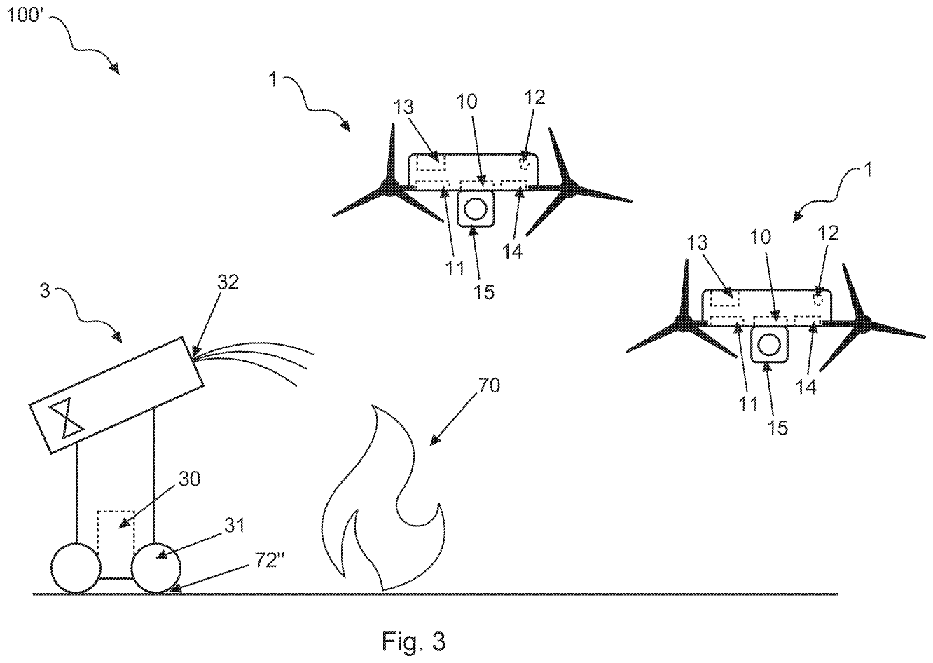

FIG. 3 schematically shows a fire-protection system 100′ in accordance with another embodiment. The fire-protection system 100′ comprises at least one fire-protection robot 1 and at least one mobile fire-fighting device 3. The mobile fire-fighting devices 3 comprise a drive unit 31 for navigating the mobile fire-fighting devices 3 from an initial position into an extinguishing position 72″. Even if only a mobile fire-fighting device 3 and only two fire-protection robots 1 are shown in FIG. 3, the fire-protection system 100′ can also comprise other mobile fire-fighting devices 3 and/or other stationary fire-fighting devices 2 and/or other fire-protection robots.

The functionality of the fire-protection robots 1 of the fire-protection system 100′ corresponds to the functionality of the fire-protection robots 1 of the fire-protection system 100, as is described in connection with FIG. 1. However, the fire-protection system 100′ differs in accordance with FIG. 3 of the fire-protection system 100 of FIG. 1 in that the fire-protection system 100′ also comprises mobile fire-fighting devices 3.

The mobile fire-fighting device 3 comprises a receiver unit 30 for receiving the activation signal comprising the target-site indication of the communication unit 12 of the fire-protection robot 1. The fire-fighting device 3 uses the target-site indication to determine the target site 70 of the fire event. The mobile fire-fighting device 3 then determines a movement path from its starting position, i.e. its current location, to the extinguishing position 72″ at some distance from the target site 70. In determining the movement path, additional information, in particular about the environment of the fire event, the weather conditions and the like, are preferably included in order to be able to carry out the most efficient fire-protection action.

In the specific embodiment of FIG. 3, the mobile fire-fighting device 3 navigates in response to the activation signal thus automatically along the movement path from the starting position in the direction of the target site 70. At the target site 70, the fire-fighting device 3 then positions itself at a place that is distanced from away from the target site in such a way that the fire-fighting device 3 is not damaged but can carry out the fire-protection action effectively. At this point, distanced from the target site, the fire-fighting device 3 then preferably aligns an extinguishing-fluid outlet in the direction of the target site 70 so that it can fight the fire and thus enters into the extinguishing position 72″. In the extinguishing position 72″ the fire-fighting device then initiates a fire-protection action.

In FIG. 3, this fire-protection action is an extinguishing action. For this purpose, the mobile fire-fighting device 3 is positioned in relation to the target site 70 so that the extinguishing fluid output from the extinguishing-fluid outlet 32 can extinguish the fire so that it is ensured that the extinguishing fluid output from the extinguishing-fluid outlet 32 can reach the fire event at the target site 70 in the specified weather conditions and the corresponding range of the fire-fighting device 3.

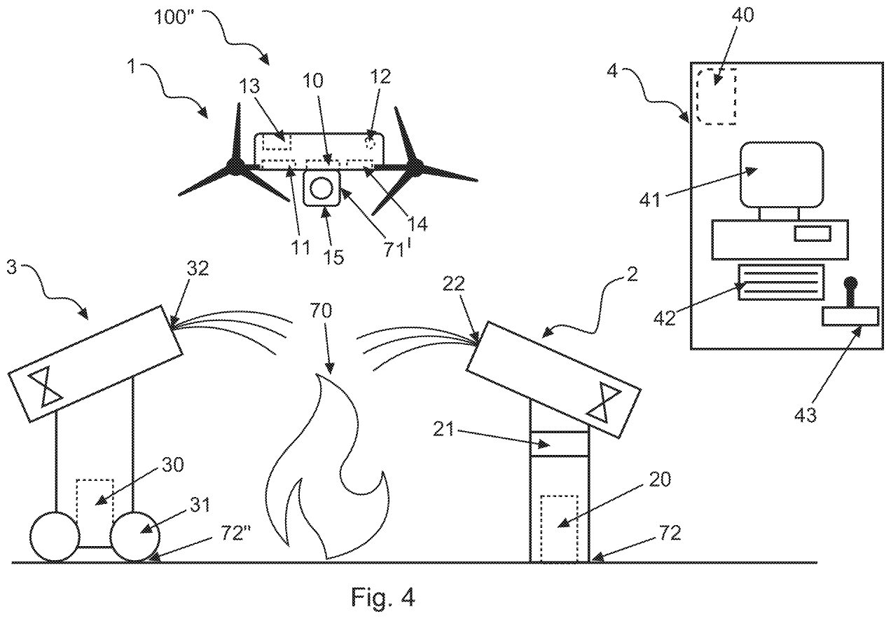

A fire-protection system 100″ in accordance with another embodiment is schematically shown in FIG. 4. The fire-protection system 100″ comprises at least one fire-protection robot 1, at least one stationary fire-fighting device 2 and at least one mobile fire-fighting device 3. The functionalities of the fire-protection robot 1, the stationary fire-fighting device 2 and the mobile fire-fighting device 3 corresponding to the functionalities to the furthest extent possible, as is described in connection with FIGS. 1 to 3.

Furthermore, the fire-protection system 100″ comprises a central device 4. The central device 4 comprises a central communication unit 40, a display unit 41 and the user interfaces 42 and 43. Unlike in the embodiments of FIGS. 1 to 3, the fire-protection robot 1, the stationary fire-fighting device 2 and the mobile fire-fighting device 3 in the embodiment of FIG. 4 are configured, in addition to self-navigation and activation, to also be manually controlled by a user.

For this purpose, the signal communication between the fire-protection robot 1 and the fire-fighting devices 2, 3 run via the central communication unit 40 of the central device 4. The central device 4 also has all information about the fire-protection area, such as its size, which sections are to be monitored by which fire-protection robot(s) 1, at which locations within the fire-protection area stationary fire-fighting devices 2 are arranged and the like.

The central device 4 receives all signals that are exchanged between the fire-protection robots 1 and the stationary and mobile fire-fighting devices via the central communication unit. Thus, the central device is also informed at all times about the (current) locations (e.g. at the safety position 71′) of the fire-protection robot 1 and the (current) locations (e.g. at the extinguishing positions 72, 72″) of the mobile fire-fighting devices 3. The central device 4 therefore has an overview of the locations of all system elements within the fire-protection area at all times.

The central device 4 is configured to output a graphical representation for the user by means of the display unit 41. This graphical representation comprises a first graphical representation 50 of the navigation grid, which defines the fire-protection area and a second graphical representation of at least one location at least one fire-protection robot 1 and/or at least a fire-fighting device 2, 3. Based on the graphical representation comprising the first and the second graphical representation, the user can then manually control the fire-protection robots 1 and/or the fire-fighting devices 2, 3 via the user interfaces 42, 43.

In the specific embodiment of FIG. 4, this means, in particular, that the user can manually navigate the fire-protection robots 1 and the mobile fire-fighting devices 3, for example, from their respective location to the target site 70. For this purpose, the fire-protection robots 1 and/or the fire-fighting devices 3 can also each comprise a camera, which is activated during manual control and transmits images to the central communication unit 40 of the central device 4. These images can then be displayed to the user on the display unit, for example, in a second window, in order to support navigation.

Furthermore, the user can also manually control the orientation of the mobile and/or stationary fire-fighting devices 2, 3 in the direction of the target site. Preferably, the second graphical representation for this comprises an orientation identification, thus indicating in which direction, for example, the extinguishing-fluid outlets of the individual fire-fighting devices are directed. Here, the user can additionally be shown the image of a camera.

In order to perform the manual control, the user preferably selects a fire-protection robot 1 and/or a mobile or stationary fire-fighting device 2.3 and performs the control for the selected fire-protection robot 1 or the selected fire-fighting device 2.3. Preferably, the other system elements continue to act automatically during this time. In other embodiments, manual control can also decommission the automatic operation of the system elements.

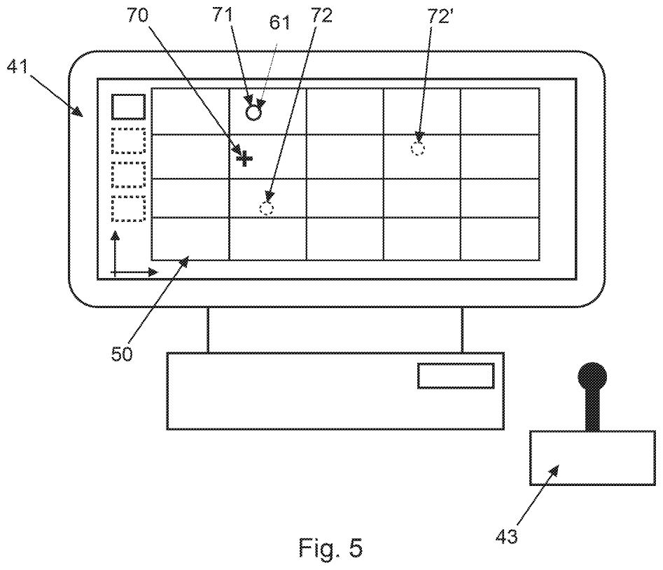

FIG. 5 schematically shows a graphical representation on the display unit 41 of the central device 4 for the purpose of manual control. Furthermore, FIG. 5 schematically shows a user interface 43, which is designed as a joystick in the embodiment of FIG. 5. The user interface is used for the manual control of the system elements.

The display unit 41 shows the user a graphical representation, in which the first graphical representation 50 of the navigation grid and the second graphical representation of the location of the fire-protection robot 1, which, in the present case, corresponds to the safety position 71, of the location of the stationary fire-fighting device 2, which, in the present case, is in the safety position 72, and of the location of the mobile fire-fighting device 3, which, in the present case, is located in the safety position 72′, are displayed in a superimposed manner. Furthermore, the graphical representation comprises a third graphical representation of the target site 70 at which a fire event has been detected, as well as a graphical representation of the information about the environment, such as information regarding the current weather conditions for example, and a plurality of selection tools 61, with which the user can select the fire-protection robots 1 and/or fire-fighting devices 2, 3 to be controlled.

In the specific embodiment of FIG. 5, the user has selected the fire-protection robot 1 in safety position 71 via the selection means 61 in order to control it manually. The user can then use the user interface 43 to control the fire-protection robot 1, for example, away from the safety position 71 from the target site 70 of the fire event, for example, in the parking position when the fire-protection robot is no longer required and/or indicates that it must be charged. In the embodiment of FIG. 5, this control is purely based on the grid coordinates. The user is shown the movement of the fire-protection robot 1 in real time, and that occurring by continuously adjusting the graphical representation of the location of the fire-protection robot 1 away from the protection position 71. This means that the graphical representation of the location is continuously adapted to the movement of the fire-protection robot 1.

After the user has stopped controlling the fire-protection robot 1, he/she can then select via the selection means 61 the stationary fire-fighting device 2 in the extinguishing position 72 or the mobile fire-fighting device 3 in the extinguishing position 72′ and control it accordingly manually, as is described in connection with FIG. 4. Thus, a fire-protection system 100″ can be provided, in which an automatic as well as manual control of the individual system elements is possible.

Even if a manual control of the at least one fire-protection robot 1 and/or the at least one stationary and/or mobile fire-fighting device 2, 3 has been explained in connection with FIG. 5, the graphical representation, as is schematically shown in FIG. 5, can also only serve to show the user the automatic navigation of the individual system elements through the fire-protection area so that the user can get an idea of the situation without actively intervening in the process.

### LIST OF UTILIZED REFERENCE NUMBERS

Fire-protection robot 1
Control unit 10
Fire-sensor unit 11
Communication unit 12
Processor unit 13
Environmental sensor unit 14
Camera 15
Fire-fighting unit 16
Stationary fire-fighting device 2
Mobile fire-fighting device 3
Receiver unit 20, 30
Alignment unit 21
Extinguishing-fluid outlet 22, 32
Drive unit 31
Central device 4
Central communication unit 40
Display unit 41
User interface 42, 43
First graphical representation 50
Selection medium 61
Target site of the fire event 70
Safety position 71, 71′
Extinguishing position 72, 72′, 72″
Fire-protection system 100, 100′, 100″

1. Fire-protection robot, comprising:
a control unit configured to move the fire-protection robot along a specified navigation path; and
a fire-sensor unit configured to detect at least one fire characteristic along the specified navigation path; and
a communication unit configured to transmit an activation signal to at least one fire-fighting device that is separate from the fire protection robot in response to the detection of at least one fire characteristic.

2. The fire-protection robot according to claim 1, wherein the control unit determines the specified navigation path based on navigation data which comprises a navigation grid with a plurality of grid coordinates, wherein the navigation grid defines a fire-protection area.

3. The fire-protection robot according to claim 1, wherein the control unit is also configured to adjust the specified navigation path in response to the detection of at least one fire characteristic.

4. The fire-protection robot according to claim 1, further comprising:
a processor unit that is configured to determine a target site of a fire event based on at least one fire characteristic and navigation data.

5. The fire-protection robot according to claim 3, further comprising:
an environmental sensor unit configured to determine at least one ambient parameter along the navigation path; wherein
the control unit is configured to adjust the navigation path in response to the detection of at least one fire characteristic based on at least one ambient parameter.

6. The fire-protection robot (1) according to claim 4, further comprising:
at least one camera that is configured to generate at least one image of the location of the fire protection event in response to the detection of at least one fire characteristic.

7. The fire-protection robot according to claim 1, wherein
the control unit is further configured to receive an external navigation signal and adjust the navigation path based on the external navigation signal; and/or
wherein the communication unit is further configured to transmit an alarm signal to a receiver unit of an external fire-protection unit in response to the detection of at least one fire characteristic, in particular, wherein the alarm signal comprises the target site indication.

8. The fire-protection robot according to claim 1, further comprising a fire-fighting unit.

9. A fire-protection system, comprising:
at least one fire-protection robot according to claim 1; and
at least one fire-fighting device which is configured to be separate from the fire-protection robot, the fire-fighting device comprising a receiver unit for receiving the activation signal from the fire-protection robot, wherein the fire-fighting device is configured to initiate a fire-protection action in response to the activation signal.

10. The fire-protection system according to claim 9, furthermore comprising
a central device comprising a central communication unit which is configured to receive the activation signal from which at least one fire-protection robot and, in response to the reception, to transmit at least one fire-fighting device, wherein the central device comprises a display unit and a user interface, wherein
the display unit is configured
to use navigation data, which comprise a navigation grid with a plurality of grid coordinates, to generate a first graphical representation of the navigation grid, wherein the navigation grid defines the fire-protection area, and further, to generate a second graphical representation of a location of at least one fire-protection robot and/or a location of the at least one fire-fighting device, and
to display the first and the second graphical representation to a user together; and wherein
the user interface is configured to receive input from the user and to generate a user control signal based on the inputs.

11. The fire-protection system according to claim 10, wherein
the user-control signal comprises an external navigation signal for at least one fire-protection robot; and
the central communication unit is configured to transmit the external navigation signal to at least one fire-protection robot.

12. The fire-protection system according to claim 9, furthermore comprising:
at least one fire-fighting device which is configured as a stationary fire-fighting device, wherein:
the receiver device is configured to receive a target-site indication for the target site of the fire event, and wherein
the fire-fighting device comprises at least one alignment unit which is configured to align an extinguishing-fluid outlet of the fire-fighting device based on the target-site indication in the direction of the target site.

13. The fire-protection system according to claim 9, furthermore comprising;
at least one fire-fighting device which is implemented as a mobile fire-fighting device comprising at least one drive unit.

14. Method for operating a fire-protection system, comprising the following steps:
(a) moving at least one fire-protection robot along a specified navigation path
(b) detecting at least one fire characteristic along the specified navigation path
(c) transmitting, in response to the detection of at least one fire characteristic, an activation signal to at least one fire-fighting device, wherein the fire-fighting device is provided separately from the fire-protection robot.

15. The method according to claim 14, furthermore comprising:
(d) activating the least one fire-fighting device in response to the activation signal.

16. The method according to claim 14, wherein step (c) further comprises a transmission of a target-site indication for a target site of a fire event, and the method further comprising:
(e) automatically navigating at least one fire-fighting device based on the target-site indication to the target site of the fire event.

17. The fire-protection system according to claim 13, wherein the receiver unit is also configured to receive a target-site indication for the target site of the fire event, and wherein the at least one drive unit is configured to automatically navigate the at least one fire-fighting device to the target site of the fire event based on the target-site indication and to align an extinguishing-fluid outlet of the fire-fighting device to the target site of the fire event upon reaching the target site.
